(19) United States
(12) Patent Application Publication
(10) Pub. No.: US 2013/0256197 A1
(43) Pub. Date: Oct. 3, 2013

(54) FLOW CHANNEL DEVICE, PARTICLE SORTING APPARATUS, AND PARTICLE SORTING METHOD

(71) Applicant: SONY CORPORATION, Tokyo (JP)

(72) Inventor: Yoichi Katsumoto, Tokyo (JP)

(73) Assignee: Sony Corporation, Tokyo (JP)

(21) Appl. No.: 13/851,668

(22) Filed: Mar. 27, 2013

(30) Foreign Application Priority Data
Apr. 3, 2012 (JP) 2012-084511
Jan. 23, 2013 (JP) 2013-010546

(51) Int. Cl. B03C 7/00

(52) U.S. Cl. CPC B03C 7/00
USPC 209/127.1

(57) ABSTRACT

A flow channel device includes a flow channel in which a fluid containing a particle flows, a plurality of branch channels branched from the flow channel, and an electrode unit. The electrode unit includes a first electrode having a first area and a second electrode having a second area different from the first area, and is configured to form a guide electrical field in the flow channel, which guides the particle to a predetermined branch channel out of the plurality of branch channels. The second electrode is opposed to the first electrode so that the flow channel is sandwiched between the first electrode and the second electrode.

### CROSS REFERENCES TO RELATED APPLICATIONS

The present application claims priority to Japanese Priority Patent Application JP 2012-084511 filed in the Japan Patent Office on Apr. 3, 2012, and JP 2013-010546 filed in the Japan Patent Office on Jan. 23, 2013, the entire content of which is hereby incorporated by reference.

### BACKGROUND

The present disclosure relates to a flow channel device, a particle sorting apparatus, and a particle sorting method for circulating particles such as cells.

As apparatuses that sort particles such as cells, a fluorescence flow cytometer and a cell sorter are known. In those apparatuses, under an appropriate vibration condition (generally, exit flow rate of several m/s and vibration counts of tens of kHz), cells are closed in a gas-liquid interface at an ejection opening by an ambient fluid, and charges are given to the cells at the same time. The cells fly as droplets in a direction in accordance with a charge quantity in air to which a static electric field is applied and are eventually sorted into a sorting container provided outside a flow channel.

The technology is useful in the case where the flow rate is relatively high as described above. For a flow cytometer for a low flow rate or a dielectric cytometer, it is difficult to make droplets and satisfy an ejection condition for the droplets. In view of this, it is desirable to perform a sorting operation in a flow channel having branches and hold cells in a rear stage.

As a sorting mechanism in the flow channel, a method for changing a flow direction of a fluid by using a piezoelectric element or the like and indirectly driving cells in the fluid. However, the responsiveness of the mechanical element is an approximately millisecond. In consideration of the responsiveness of a pressure wave of the flow channel, a sorting speed for the cells has a limitation.

On the other hand, as a method for directly driving the cells, a dielectrophoresis method has been proposed. Japanese Patent Translation Publication No. 2003-507739 discloses that a difference of a dielectrophoretic force between cell types and a difference of a sedimentation rate therebetween are used, thereby separating cells by type which flow in a flow channel in which an electrode is provided.

### SUMMARY

However, comparing to a difference of the dielectrophoretic force due to a difference of a size, a shape, or the like between particles, the difference of the dielectrophoretic force due to the difference of particle types is significantly small. Therefore, it is expected that the sorting method disclosed in Japanese Patent Translation Publication No. 2003-507739 does not work well in actuality.

In view of the above-mentioned circumstances, it is desirable to provide a particle sorting apparatus capable of sorting particles appropriately and a flow channel device and a particle sorting method that are used therefor.

According to an embodiment of the present disclosure, there is provided a flow channel device including a flow channel, a plurality of branch channels, and an electrode unit.

The flow channel is formed so that a fluid containing a particle flows therein.

The plurality of branch channels are branched from the flow channel.

The electrode unit includes a first electrode having a first area and a second electrode having a second area different from the first area, and the second electrode is opposed to the first electrode so that the flow channel is sandwiched between the first electrode and the second electrode. Further, the electrode unit is configured to form a guide electrical field in the flow channel, which guides the particle to a predetermined branch channel out of the plurality of branch channels.

The areas of the first electrode and the second electrode are different, so it is possible to form the guide electrical field which has a non-uniform electrical flux density and guides the particle to the predetermined branch channel in the flow channel. As a result, the flow channel device is capable of appropriately sorting the particle.

The first electrode may be an electrode having a first width in a width direction of the flow channel, and the second electrode may be an elongated electrode having a second width smaller than the first width in the width direction of the flow channel.

With this structure, the guide electrical field is easily formed, and the reliability of sorting the particle can be increased. Further, the second electrode is the elongated shape, and as the first width is larger than the second width, the degree of freedom of the positioning of the second electrode relative to the positioning of the first electrode becomes higher in the manufacture of the flow channel device. In other words, precise alignment of the second electrode relative to the first electrode becomes unnecessary.

The second electrode may include a linear portion provided along a mainstream direction of the fluid in the flow channel, and a direction change portion provided to change a direction from the linear portion toward the predetermined branch channel. A part of the second electrode on the downstream side is provided so that the direction thereof is changed toward the predetermined branch channel, so the particle is capable of moving along the branch channel.

The electrode unit may include a plurality of second electrodes. With this structure, the electrode unit is capable of forming a line of electric force with the guide electrical field in various forms.

At least two electrodes out of the plurality of second electrodes may be a pair of guide electrodes elongated along a mainstream direction of the fluid. The guide electrodes have elongated shapes, so the pair of guide electrodes can be formed into two band shapes or rail shapes, and the guide electrical field is easily formed. As a result, it is possible to increase sorting accuracy of the particle.

The pair of guide electrodes may include a main portion and an entrance portion. The main portion may be formed so that a distance between the pair of guide electrodes is a first distance. The entrance portion may be provided on an end portion of the pair of guide electrodes on an upstream side and formed so that a distance between the pair of guide electrodes is a second distance longer than the first distance. With this structure, the particle that flows from the upstream side of the particle is easily attracted to the entrance portion. As a result, an allowable range of an existence position of the particle in the flow channel width direction can be set to be large.

The distance between the pair of guide electrodes in the entrance portion may be gradually increased toward the upstream side.

The plurality of branch channels may include a first branch channel, which is the predetermined branch channel, and a second branch channel adjacent to the first branch channel. In this case, the second distance may be longer than a distance from an inner side surface of the flow channel which is provided on the second branch channel side in a width direction of the flow channel to a branch position of the first branch channel and the second branch channel in the width direction of the flow channel. Alternatively, at least a part of the entrance portion of the guide electrode of the pair of guide electrodes, which is provided on the first branch channel side in a width direction of the flow channel, may be disposed on the first branch channel side in the width direction of the flow channel in relation to a branch position of the first branch channel and the second branch channel. With the arrangement and structure of the guide electrodes, the particle that flows from the upstream side of the flow channel is easily attracted to the entrance portion.

The electrode unit may be configured to form the guide electrical field by voltages having the same potential which are applied to the plurality of second electrodes.

The first electrode may be a common electrode, and the second electrode may be an electrode to which a voltage is actively applied.

The electrode unit may include a switching portion that switches a direction of a flow of the particle. By switching the direction of the particle with the switching portion, it is possible to reliably switch the flow of the particle on the upstream side of the second branch channel and reliably guide the particle to a desired branch channel.

The electrode unit may include a pair of guide electrodes elongated along a mainstream direction of the fluid and serving as the second electrodes, and a switching portion configured to switch a direction of a flow of the particle.

The pair of guide electrodes may include a linear portion provided along the mainstream direction of the fluid in the flow channel, and a direction change portion provided to change a direction from the linear portion toward the predetermined branch channel. The switching portion may be disposed between the linear portion and the direction change portion.

According to another embodiment of the present disclosure, there is provided a particle sorting apparatus including a flow channel device, a measurement unit, and a signal generation unit.

The flow channel device includes a flow channel, a plurality of branch channels, a measurement electrode unit, and a sorting electrode unit.

The flow channel is formed so that a fluid containing a particle flows.

The plurality of branch channels are branched from the flow channel.

The measurement electrode unit is provided on a first position of the flow channel.

The sorting electrode unit includes a first electrode having a first area and a second electrode having a second area different from the first area, and the second electrode is opposed to the first electrode so that the flow channel is sandwiched between the first electrode and the second electrode. Further, the sorting electrode unit is provided on a second position on a downstream side from the first position of the flow channel, and is configured to form a guide electrical field in the flow channel, which guides the particle to a predetermined branch channel out of the plurality of branch channels.

The measurement unit is configured to measure an impedance that depends on the particle by applying an AC voltage to the measurement electrode unit.

The signal generation unit is configured to generate a sorting signal that gives an instruction to sort the particle by the guide electrical field on the basis of the impedance measured and apply the sorting signal to the sorting electrode unit.

The sorting electrode unit may include a switching portion that switch a direction of a flow of the particle.

The signal generation unit may be configured to control a voltage signal applied to the switching portion in accordance with a sorting process of the particle based on the impedance measured.

According to another embodiment of the present disclosure, there is provided a particle sorting method including the following steps.

A fluid containing a particle is caused to flow in a flow channel.

An impedance that depends on the particle is measured by applying an AC voltage to a measurement electrode unit provided on a first position of the flow channel.

A sorting signal that gives an instruction to sort the particle is generated on the basis of the impedance measured.

By applying the sorting signal generated to a sorting electrode unit, a guide electrical field that guides the particle to a predetermined branch channel out of a plurality of branch channels branched from the flow channel is formed in the flow channel. The sorting electrode unit includes a first electrode having a first area and a second electrode having a second area different from the first area and is provided on a second position on a downstream side from the first position of the flow channel, and the second electrode is opposed to the first electrode so that the flow channel is sandwiched between the first electrode and the second electrode.

As described above, according to the embodiments of the present disclosure, it is possible to appropriately sort the particle.

Additional features and advantages are described herein, and will be apparent from the following Detailed Description and the figures.

### BRIEF DESCRIPTION OF THE FIGURES

FIG. 1 is a schematic diagram showing the structure of a particle sorting apparatus according to an embodiment of the present disclosure;

FIG. 2 is a perspective view showing an example of a flow channel device according to a first embodiment shown in FIG. 1;

FIG. 3 is a perspective view showing a schematic structure of a sorting unit shown in FIG. 2;

FIG. 4 is a plan view showing the sorting unit;

FIG. 5 is a cross-sectional view of the sorting unit taken along the linen A-A;

FIG. 6 is a diagram for explaining an operation of the sorting unit in the flow channel device;

FIG. 7 is a diagram showing an example of sizes of parts of a sorting electrode unit;

FIG. 8A is a diagram showing an electrical field intensity distribution on an x-y plane at a position of z=10 μm, and FIG. 8B is a diagram showing an electrical field intensity distribution on a y-z plane at a position of x=50 μm;

FIG. 9A is a diagram showing an intensity distribution of a dielectrophoretic force generated in a rightward y direction on the y-z plane at a position of x=50 μm, and FIG. 9B is a diagram showing an intensity distribution of a dielectrophoretic force generated in a leftward y direction;

FIG. 10A is a diagram showing an intensity distribution of a dielectrophoretic force generated in an upward z direction on the y-z plane at the position of x=50 μm, and FIG. 10B is a diagram showing an intensity distribution of a dielectrophoretic force generated in a downward z direction;

FIG. 11 is a diagram showing the degree of the dielectrophoretic force that operates in a y direction on a boundary where positive and negative dielectrophoretic forces in the z direction are switched at a position of the height z;

FIG. 12 is a diagram showing a simulation result of tracks of particles in the case where the particles flow into a flow channel area of a guide electrode structure from different positions in the y direction;

FIG. 13 is a schematic perspective view showing a sorting unit of a flow channel device according to a second embodiment of the present disclosure;

FIG. 14 is a schematic plan view of the sorting unit shown in FIG. 13;

FIG. 15 is a diagram showing a simulation result of tracks of particles with the flow channel device;

FIGS. 16A and 16B are diagrams showing design examples of an approach section of the guide electrode structure according to the first and second embodiments, respectively;

FIG. 17 is a schematic plan view showing a sorting unit of a flow channel device according to a third embodiment of the present disclosure;

FIG. 18 is a plan view schematically showing a guide electrode structure according to another embodiment;

FIG. 19 is a plan view schematically showing a guide electrode structure according to another embodiment;

FIG. 20 is a plan view schematically showing a guide electrode structure according to another embodiment;

FIG. 21 is a plan view showing a sorting electrode unit of a flow channel device according to a fourth embodiment of the present disclosure;

FIG. 22 is a plan view mainly showing a common electrode of the sorting electrode unit shown in FIG. 21;

FIG. 23A is a diagram showing an intensity distribution of an electrical field at a flow channel depth of z=10 μm, FIG. 23B is a diagram showing an intensity distribution of a dielectrophoretic force generated only in an upward direction out of dielectrophoretic forces generated in the z direction, and FIG. 23C is a diagram showing an intensity distribution of a dielectrophoretic force generated only in a downward direction out of the dielectrophoretic forces generated in the z direction with the electrical field shown in FIG. 23A;

FIGS. 24A to 24C are diagrams showing intensity distributions corresponding to FIGS. 23A to 23C at the flow channel depth of 20 μm, respectively;

FIG. 25 is a diagram for explaining the behavior of a particle in the case where voltages V1, V2 and Vx are applied to the electrodes; and

FIG. 26 is a diagram of FIG. 25 viewed in the y direction.

### DETAILED DESCRIPTION

Hereinafter, embodiments of the present disclosure will be described with reference to the drawings.

(Structure of Particle Sorting Apparatus)

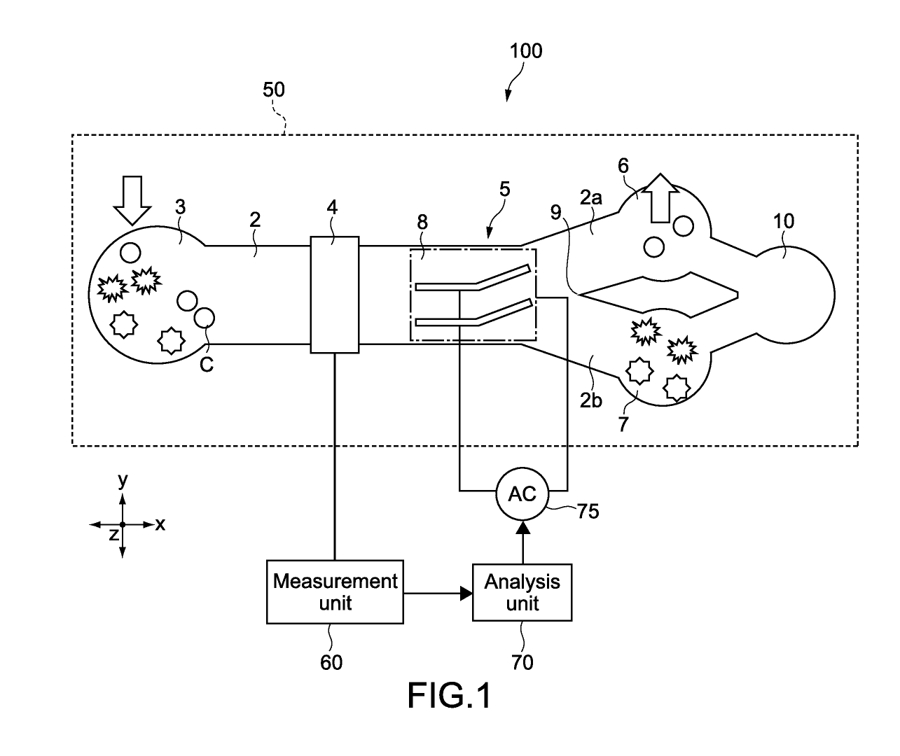

FIG. 1 is a schematic diagram showing the structure of a particle sorting apparatus according to an embodiment of the present disclosure.

A particle sorting apparatus 100 is provided with a flow channel device 50, a measurement unit 60, and an analysis unit 70. In the flow channel device 50, from the upstream side thereof, an input unit 3, a flow channel (main flow channel) 2, a measurement electrode unit 4, a sorting unit 5, branch channels 2a and 2b, particle takeout units 6 and 7, and a flowage unit 10 are provided.

Into the input unit 3, a fluid (liquid) containing cells as particles C sampled is input with the use of a pump (not shown), for example. As the liquid containing the particles C, a normal saline solution can be mainly used. In the case where a normal saline solution containing suspended particles (living cells such as white blood cells, polystyrene beads, or the like) flows in a flow channel, an electrical field is generated in the flow channel as will be described later, with the result that the particles are subjected to a negative dielectrophoretic force.

In the flow channel 2, the liquid that is input from the input unit 3 flows. A direction of a main stream of the liquid is an x direction in FIG. 1.

In the measurement unit 60, an AC voltage having an arbitrary frequency within a predetermined frequency range is applied to the measurement electrode unit 4. For example, with respect to individual cells that flow in the flow channel 2, a complex dielectric constant that depends on each cell is measured for multipoint frequencies (three or more points, typically, about 10 to 20 points) within a frequency range (for example, 0.1 MHz to 50 MHz) of an AC voltage, in which a dielectric relaxation phenomenon occurs. It should be noted that the measurement unit 60 measures an impedance from a detection signal obtained from the measurement electrode unit 4 and obtains, from the impedance measured, the complex dielectric constant by a known electric conversion expression.

Examples of an amount electrically equivalent to the complex dielectric constant include a complex impedance, a complex admittance, a complex capacitance, a complex conductance, and the like. Those can be converted to each other by a simple electrical quantity conversion. Further, the measurement of the complex impedance or the complex dielectric constant includes a measurement of only a real part or only an imaginary part.

The analysis unit 70 receives information of the complex dielectric constant of the particles C measured by the measurement unit 60, determines whether the particles C have to be sorted or not on the basis of the complex dielectric constant, and in the case where the particles have to be sorted, generates a sorting signal. In this case, the analysis unit 70 functions as a signal generation unit.

Out of the plurality of kinds of particles C input from the input unit 3, the sorting unit 5 sorts particles C as targets into the particle takeout unit 6 and sorts remaining particles C into the particle takeout unit 7. The sorting unit 5 has a sorting electrode unit 8. A position (second position) on which the sorting electrode unit 8 is provided is a downstream side from a position (first position) on which the measurement electrode unit 4 is provided.

The measurement unit 60 and the analysis unit 70 may be formed of hardware or formed of both of hardware and software. The measurement unit 60 and the analysis unit 70 may be one apparatus physically.

To the sorting electrode unit 8, a DC or AC drive voltage in accordance with the sorting signal output from the analysis unit 70 is applied. As a result, the sorting electrode unit 8 generates a guide electrical field in the flow channel 2. The guide electrical field is such an electrical field that the particles C are guided to predetermined one of the plurality of branches 2a and 2b. The sorting electrode unit 8 will be described later in detail.

The branches 2a and 2b are flow channels that are branched from the flow channel 2. The branch channel 2a is connected to the particle takeout unit 6, and the branch channel 2b is connected to the particle takeout unit 7. For example, in the case where the guide electrical field is not generated by the sorting electrode unit 8, the particles C flow to the particle takeout unit 7 through the branch channel 2b. On the other hand, in the case where the guide electrical field is generated in the flow channel 2 by the sorting electrode unit 8, the particles C flow to the particle takeout unit 6 through the branch channel 2a.

The particle takeout units 6 and 7 are communicated with the flowage unit 10. The liquid that has passed through the particle takeout units 6 and 7 is discharged to the outside from the flowage unit 10 by using a pump or the like.

Here, when the electrical field is applied to the particles C that exist in the liquid, an induced dipole moment is generated due to a difference of a polarizability between a medium (liquid) and the particles C. In the case where a space distribution of the applied electrical field, that is, a space distribution of an electrical flux density is not uniform, the electrical field intensity differs in the vicinity of the particles C, so a dielectrophoretic force indicated by the expression (1) is generated due to the induced dipole.

In the expression (1), ∈′m, ∈v, R, and Erms represent the real part of a complex relative permittivity (complex relative permittivity is defined by the expression (2)) of the medium, a vacuum dielectric constant, a particle radius, and an RMS value of the electrical field applied, respectively. Further, K is Clausius-Mossotti function indicated in the expression (3), and ∈*p and ∈*m represent dielectric constants of the particles C and the medium respectively.

$$\begin{matrix}〈 {\overline{F}}_{DEP} ( t ) 〉 = 2 {πɛ}^{′} m ɛ {vR}^{3} Re [ K ( ω ) ] ∇ {E}_{rms}^{2} & ( 1 ) \\ {ɛ}^{*} = {ɛ}^{′} - i {ɛ}^{″} + \frac{κ}{i {ωɛ}_{v}} & ( 2 ) \\ K ( ω ) = \frac{{ɛ}^{*} p - {ɛ}^{*} m}{{ɛ}^{*} p + 2 {ɛ}^{*} m} & ( 3 )\end{matrix}$$

As described above, in Japanese Patent Translation Publication No. 2003-507739, an attention is focused on a difference of K between particle types, and the particles are sorted by using only a dielectrophoresis method. In contrast, the particle sorting apparatus 100 according to the present disclosure does not use the difference of the dielectrophoretic force between particle types (frequency dependency). In accordance with the sorting signal transmitted from the analysis unit 70, the particle sorting apparatus 100 turns on and off the guide electrical field or performs an amplitude modulation and application, and performs sorting only for the particles C as the sorting targets by a sufficient dielectrophoretic force even if the particle groups have variations in particle size or physicality.

The particles C as the targets to be guided to the branch channel 2a by generating the guide electrical field by the sorting electrode unit 8 are referred to as target particles hereinafter. The particles C guided to the branch channel 2b without generating the guide electrical field are referred to as non-target particles hereinafter. The target particles and the non-target particles are normal cells and dead or cancerous cells, respectively, for example.

In advance, a storage device (not shown) only has to store information (and/or information of a range of the complex dielectric constant of the non-target particles) of a range of the complex dielectric constant of the target particles. The storage device is a device that is accessible by at least the analysis unit 70. On the basis of the information stored in the storage device, the analysis unit 70 determines whether the complex dielectric constant of the particles C which is measured by the measurement unit 60 falls within the range of the complex dielectric constant of the target particles or not (whether the complex dielectric constant of the particles C falls within the range of the complex dielectric constant of the non-target particles). The determination is performed in real time immediately after the measurement of the complex dielectric constant by the measurement unit 60. Then, in the case where the analysis unit 70 determines that the particles C as the measurement targets are target particles, the analysis unit 70 outputs the sorting signal and applies a predetermined drive voltage to the sorting electrode unit 8.

### Flow Channel Device

### First Embodiment

### Structure of Flow Channel Device

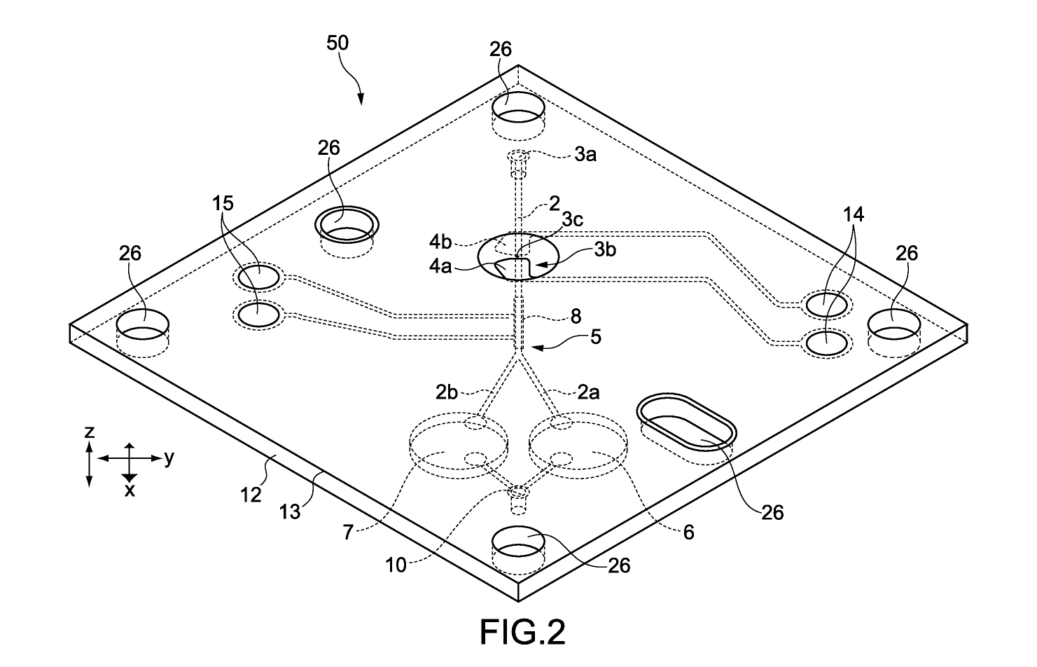

FIG. 2 is a perspective view showing an example of the flow channel device 50 shown in FIG. 1.

As shown in FIG. 2, the flow channel device 50 has a chip shape and includes a substrate 12 and a sheet-shaped member 13 formed of a polymer film or the like. On the substrate 12, the flow channel 2, the branch channels 2a and 2b, a liquid input unit 3a serving as the input unit 3, the particle takeout units 6 and 7, and the flowage unit 10 are provided. Those are configured by forming grooves or the like on the surface of the substrate 12 and covering the surface with the sheet-shaped member 13.

A particle input unit 3b to which the liquid containing the particles C is input has a minute input hole 3c formed on the sheet-shaped member 13. If the liquid containing the particles C is dropped in the input hole 3c with a pipette from above, the liquid flows to the downstream of the flow channel 2 via the input hole while being involved in the liquid that flows in the flow channel 2. Because the input hole 3c is minute, the particles C do not flow into the flow channel 2 collectively but flow thereinto one by one.

A pair of measurement electrodes 4a and 4b is provided so that the input hole 3c is disposed therebetween. The measurement electrode 4a is provided on a front surface of the sheet-shaped member 13, and the measurement electrode 4b is provided on a back surface of the sheet-shaped member 13.

Upper portions of the particle takeout units 6 and 7 are covered with the sheet-shaped member 13. The sheet-shaped member 13 is stuck with a pipette, and the particles C are taken out via the pipette.

The measurement electrode unit 4 is electrically connected to electrode pads 14. The electrode pads 14 are connected to the measurement unit 60. The measurement unit 60 applies an AC voltage to the measurement electrode unit 4 through the electrode pads 14 and receives a detection signal from the measurement electrode unit 4 through the electrode pads 14.

The sorting electrode unit 8 in the sorting unit 5 is electrically connected to electrode pads 15. The analysis unit 70 applies a drive voltage to the sorting electrode unit 8 through the electrodes pads 15.

Through holes 26 are holes for fixation.

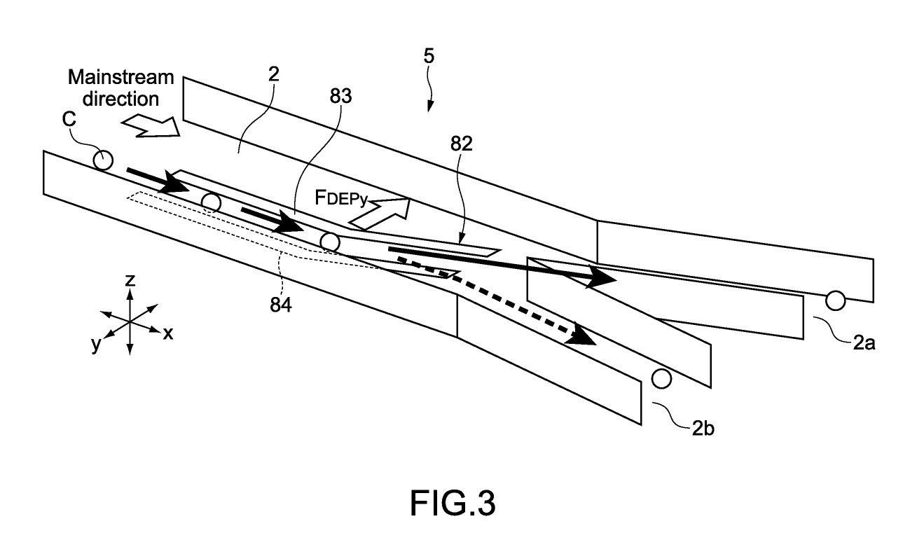

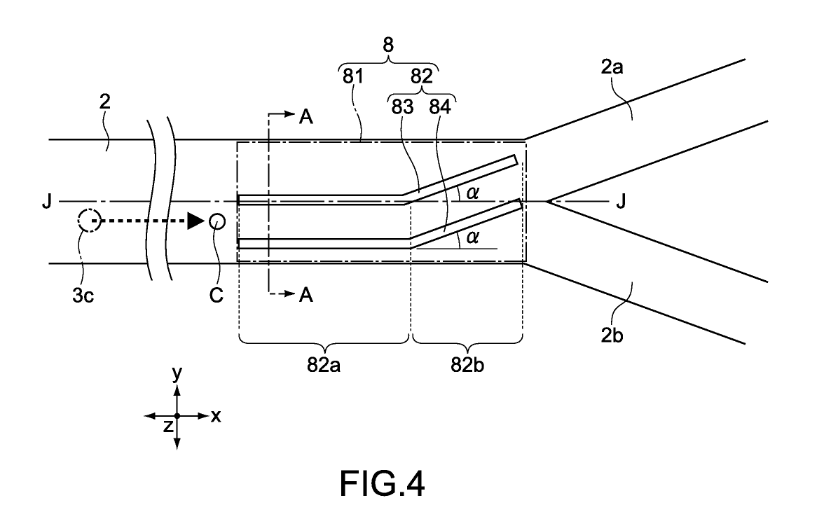

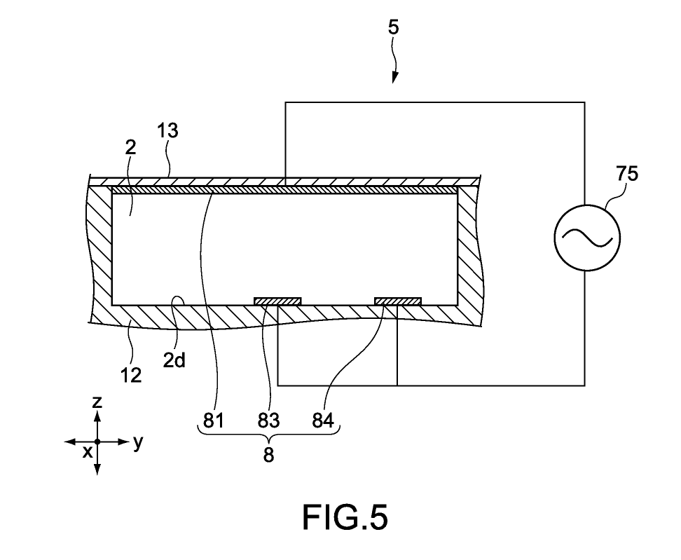

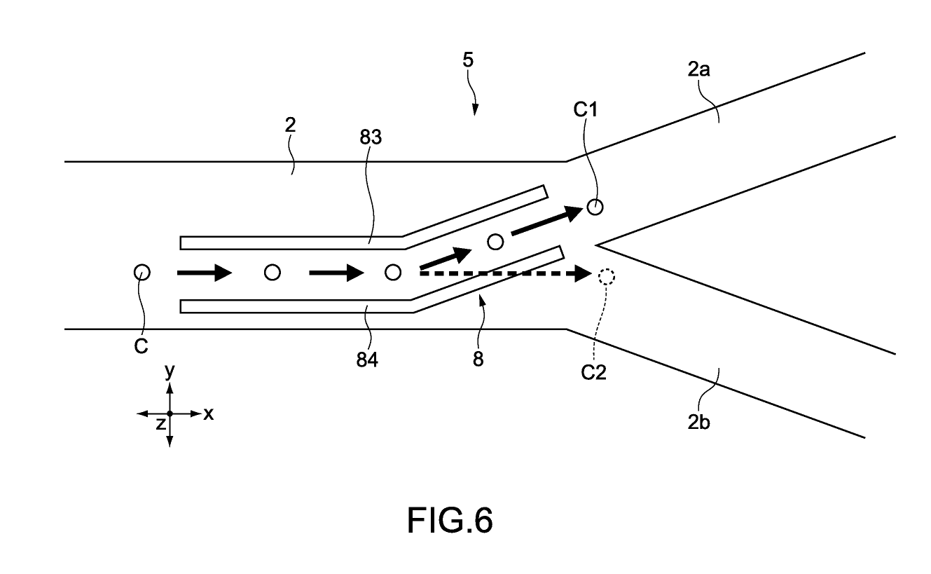

FIG. 3 is a perspective view showing a schematic structure of the sorting unit 5 shown in FIG. 2. FIG. 4 is a plan view showing the sorting unit 5. FIG. 5 is a cross-sectional view of the sorting unit 5 taken along the linen A-A of FIG. 4.

The sorting electrode unit 8 is provided with a common electrode (first electrode) 81 having a first area and guide electrodes (second electrodes) 83 and 84 each having a second area different from the first area. In this embodiment, the second area is smaller than the first area. In the following description, the pair of guide electrodes 83 and 84 is referred to as a “guide electrode structure 82”.

The common electrode 81 is provided on the back surface side of the sheet-shaped member 13, for example, and the guide electrode structure 82 is provided on a bottom surface 2d in the flow channel 2. End portions of the common electrode 81 and the guide electrode structure 82 on the upstream side are disposed on the downstream side in relation to the particle input unit 3b, and end portions thereof on the downstream side are disposed on the upstream side in relation to the branch channels 2a and 2b.

The common electrode 81 may be provided on the front surface side of the sheet-shaped member 13, for example.

The common electrode 81 functions as a ground electrode. The common electrode 81 has a width (first width) in a y direction, which is substantially the same as the width of the flow channel 2 in the y direction, and has a length in the x direction to such an extent that the guide electrode structure 82 is covered therewith as shown in FIG. 4, for example. The common electrode 81 typically has a planar rectangular shape. The length of the common electrode 81 in the x direction may be longer or shorter than the length of the guide electrode structure 82 by a predetermined length.

The number of guide electrodes is multiple, for example, two. The guide electrodes 83 and 84 each have an elongated shape (band shape or rail shape) in a direction in which a liquid flows. One width (second width) of the guide electrode 83 or 84 in the y direction is formed to be smaller than that of the common electrode 81. The guide electrode structure 82 includes a linear portion 82a provided along the x direction, which is a mainstream direction of the liquid, and a direction change portion 82b provided so that a direction is changed from the linear portion 82a toward the branch channel 2a, that is, provided so as to be bent. A bend angle α (see, FIG. 4) will be described later. The linear portion 82a functions as an approach section of particles up to the direction change portion 82b.

As shown in FIG. 4, the linear portion 82a is disposed so as to be closer to the branch channel 2b side in the y direction in the flow channel 2. More specifically, in the linear portion 82a, an area between the guide electrode 83 on the inner side in the y direction in the flow channel 2 and the guide electrode 84 on the outer side is disposed on the branch channel 2b side in relation to a branch reference line J. The branch reference line J indicates a position of a branch point of the branch channels 2a and 2b in the y direction. The branch reference line J is substantially the center position in the flow channel 2 in the y direction.

To the common electrode 81 and the guide electrode structure 82, an AC power source 75 operated by the analysis unit 70 applies an AC voltage, for example. The common electrode 81 is connected to the ground as described above and is kept 0 V substantially. The two guide electrodes 83 and 84 each function as an active electrode that is driven at substantially the same potential. To those electrodes, a drive voltage having an amplitude of 10 to 30 V is applied. The frequency of the AC drive voltage is 1 kHz to 100 MHz.

As shown in FIG. 4, the input hole 3c provided in the particle input unit 3b is provided on the branch channel 2b side in the y direction in relation to the branch reference line J. With this structure, the particles C input from the input hole 3c can pass on the branch channel 2b side in the y direction in relation to the branch reference line J and can path above the guide electrode structure 82.

<Sorting Operation by Flow Channel Device>

Typically, intervals between particles input through the particle input unit 3b are each set to at least a distance equal to or longer than a length of the sorting electrode unit 8 in the x direction. This is because the sorting unit 5 typically performs either one of an application of a guide electrical field for each particle C and a stop thereof, thereby performing sorting for each particle C. The flow rate of the liquid (moving speed of the particles C) can be set as appropriate, for example, set to approximately several mm/s The speed is capable of being controlled by a pump (not shown).

In the case where the drive voltage is not applied to the sorting electrode unit 8, the guide electrical field is not formed. In this case, non-target particles above the guide electrode structure 82 pass through the sorting electrode unit 8 while maintaining the position in the y direction and flow into the branch channel 2b integrally with the flow of the liquid (see, particle C2).

In the case where the drive voltage is applied to the sorting electrode unit 8, a dielectrophoretic force toward the y direction is given to the target particles above the guide electrode structure 82 by the guide electrical field. As will be described later, the guide electrical field gives the target particles such a dielectrophoretic force that the target particles are disposed between the two guide electrodes 83 and 84. Thus, the target particles move along with the liquid so as to be disposed between the guide electrodes 83 and 84. As a result, a target particle C1 flows into the branch channel 2a.

The drive voltage is applied to the guide electrode 83 at timing before the target particle flows into the sorting electrode unit 8. The timing of the application of the drive voltage is preset in accordance with a distance from the input hole 3c to the sorting electrode unit 8, the flow rate of the liquid, and the like.

<Dielectrophoretic Force by Guide Electrical Field>

A. Generation Principle

The dielectrophoretic force has a property of being formed in a direction from an area having a stronger electrical field to an area having a weaker electrical field. The larger the difference in the intensity of the electrical field is, the larger the dielectrophoretic force becomes. In the present application, an area having a weaker electrical field is formed between the guide electrodes 83 and 84. As a result, in an area from, for example, an edge of the guide electrode 83 (or 84) to the center between the guide electrodes 83 and 84, a steep difference in the intensity of the electrical field is generated. By causing the guide electrical field to be such a state, the target particle C1 is positioned in the area in the guide electrode 83.

B. Example of Sorting Electrode Unit

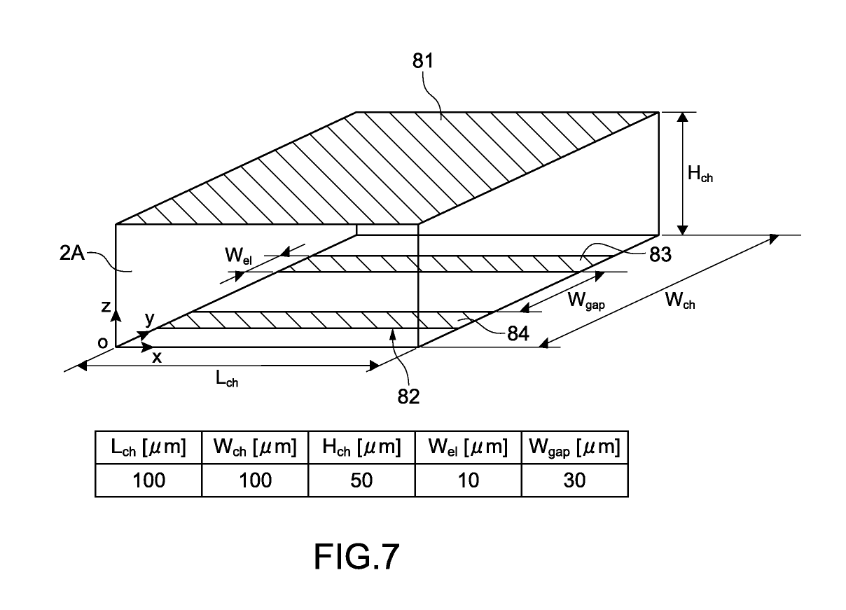

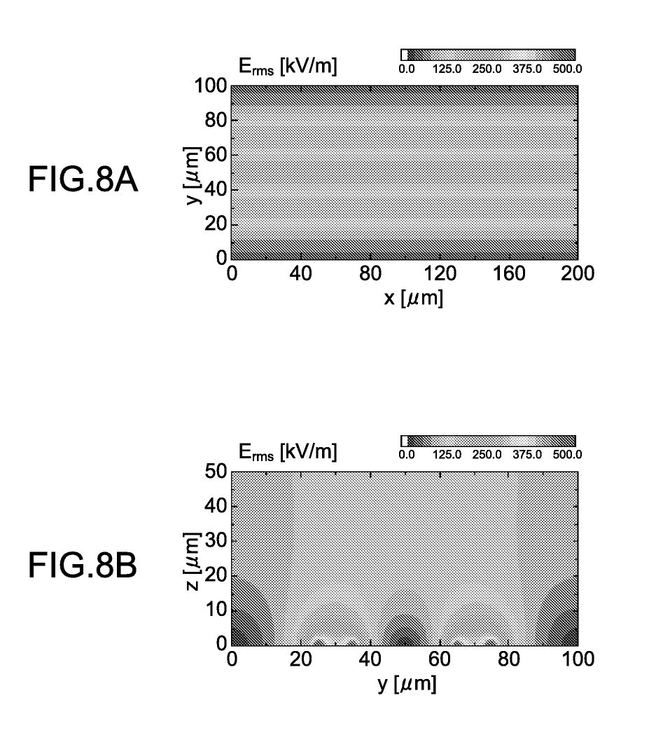

FIG. 7 is a diagram showing an example of sizes of parts of the sorting electrode unit. FIGS. 8 to 10 are diagrams each showing a simulation result of an electrical field intensity distribution for explaining the guide electrical field where the sorting electrode unit shown in FIG. 7 is generated. In actuality, the applicant of the present disclosure can disclose FIGS. 8 to 10 as color figures.

As shown in FIG. 7, a flow channel 2A having a rectangular parallelepiped shape is provided. As the sizes of the flow channel 2A, a length in the mainstream direction (x direction), a width, and a height are set to Lch (=100 μm), Wch (=100 μm), and Hch (=50 μm), respectively. A length of the common electrode 81 in the mainstream direction and a width thereof are set to Lch and Wch, respectively. A length of each guide electrode in the mainstream direction and a width thereof are set to Lch and Wel (=10 μm), respectively. Further, a width of an area of a gap in the guide electrode structure 82 is set to Wgap (=30 μm). The unit of an electrical field E in this case is kV/m.

FIG. 8A shows an electrical field intensity distribution on an x-y plane at a position of z=10 μm in the height direction. FIG. 8B shows an electrical field intensity distribution on a y-z plane at a position of x=50 μm in the mainstream direction. The guide electrodes (83 and 84) are disposed within ranges of 25 to 35 μm and 65 to 75 μm, respectively, in the range of 0 to 100 μm in the y direction.

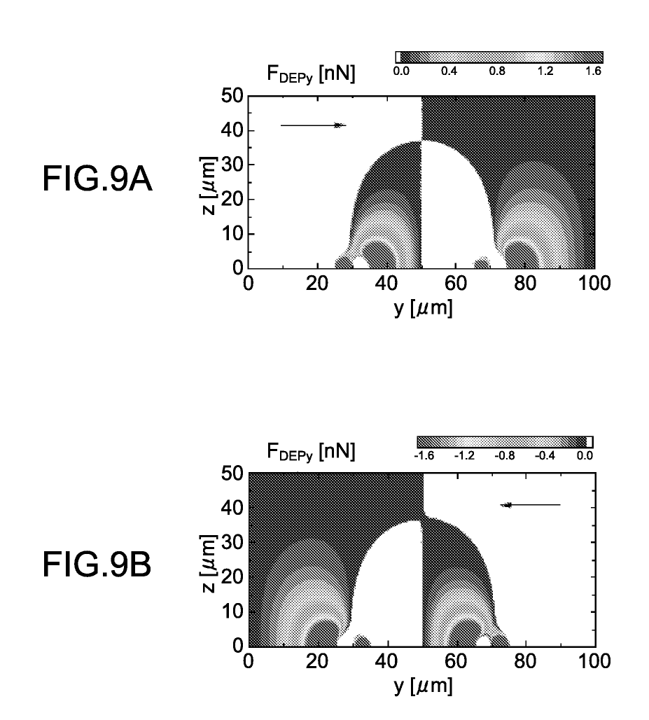

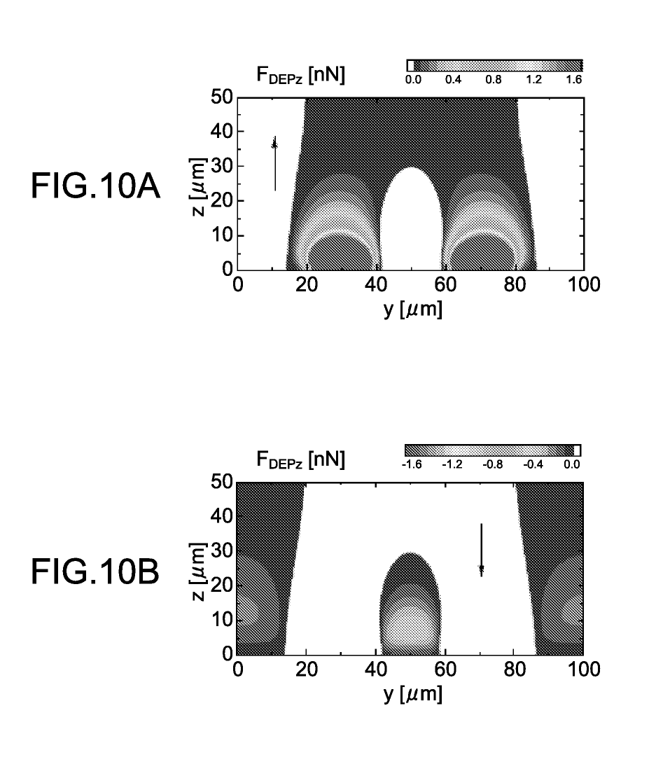

FIG. 9A shows an intensity distribution of a dielectrophoretic force generated only rightward in the figure, out of a dielectrophoretic force F_{DEPy} that operates in the y direction on the y-z plane at the position of x=50 μm. Similarly, FIG. 9B shows an intensity distribution of a dielectrophoretic force generated only leftward in the figure, out of the dielectrophoretic force F_{DEPy} on the y-z plane at the position of x=50 μm. FIG. 10A shows an intensity distribution of a dielectrophoretic force generated only upward in the figure, out of a dielectrophoretic force F_{DEPz} that operates in the z direction on the y-z plane at the position of x=50 μm. FIG. 10B shows an intensity distribution of a dielectrophoretic force generated only downward in the figure, out of the dielectrophoretic force F_{DEPz} on the y-z plane at the position of x=50 μm.

FIGS. 9A and 9B show the distributions having forms obtained by inverting each other, and the same holds true for FIGS. 10A and 10B. For example, the white area of FIG. 9A shows that the dielectrophoretic force that operates leftward is distributed, and the white area of FIG. 9B shows that the dielectrophoretic force that operates rightward is distributed. The same holds true for FIGS. 10A and 10B.

The dielectrophoretic force can be calculated on the basis of the above expression (1). The unit of the dielectrophoretic force in this case is nN.

Out of those figures, for example, as can be seen from FIG. 8B, the strongest electrical field is generated in the vicinity of the edge of each guide electrode, and the weakest electrical field is generated between the guide electrodes (83 and 84). Further, a weak electrical field also exists in the vicinity of 0 μm and 100 μm in the y direction. With reference to FIGS. 10A and 10B, it is found that intensity gradients of the dielectrophoretic force are generated within a range of about 15 μm with respect to the center between the guide electrodes (83 and 84) and within a range of about 30 μm in the z direction.

As a result, by the guide electrical field formed, a steeper intensity gradient in the y direction than the intensity gradient in the z direction can give a dielectrophoretic force that is attracted to a direction toward the center between the guide electrodes 83 and 84.

A movement performance in the y direction of the particles in the direction change portion 82b of the guide electrode structure 82 is mainly determined by the bend angle α of the direction change portion 82b the speed of the liquid in the mainstream direction. The movement performance is defined in accordance with the degree of the dielectrophoretic force that operates in the y direction on a region boundary (curved surface represented by F_{DEPz}=0) where the dielectrophoretic force in the downward z direction operates.

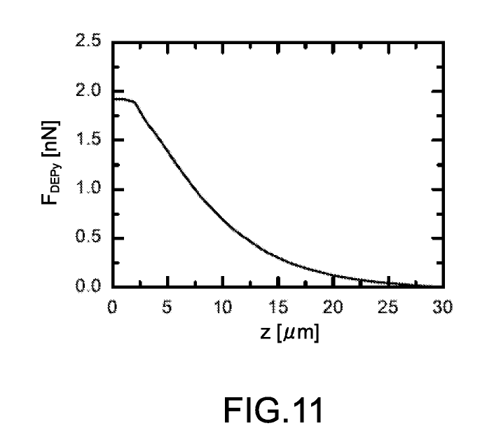

FIG. 11 is a diagram showing the degree of the dielectrophoretic force F_{DEPy} (including rightward and leftward dielectrophoretic forces that are directed toward the center between the guide electrodes 83 and 84 in this case) that operates in the y direction on a boundary where positive and negative dielectrophoretic forces in the z direction are switched at a position of the height z. From FIG. 11, it is found that F_{DEPy} is significantly changed in the z direction and is stronger as the height position is lower. That is, depending on an equilibrium position in the height direction of the movement of the particles, performance to be obtained (that is, F_{DEPy} toward inside) is significantly changed. The equilibrium position in the height direction is significantly affected by the size of the particle or a force that acts on the particle from the liquid in proximity to a wall surface of the flow channel.

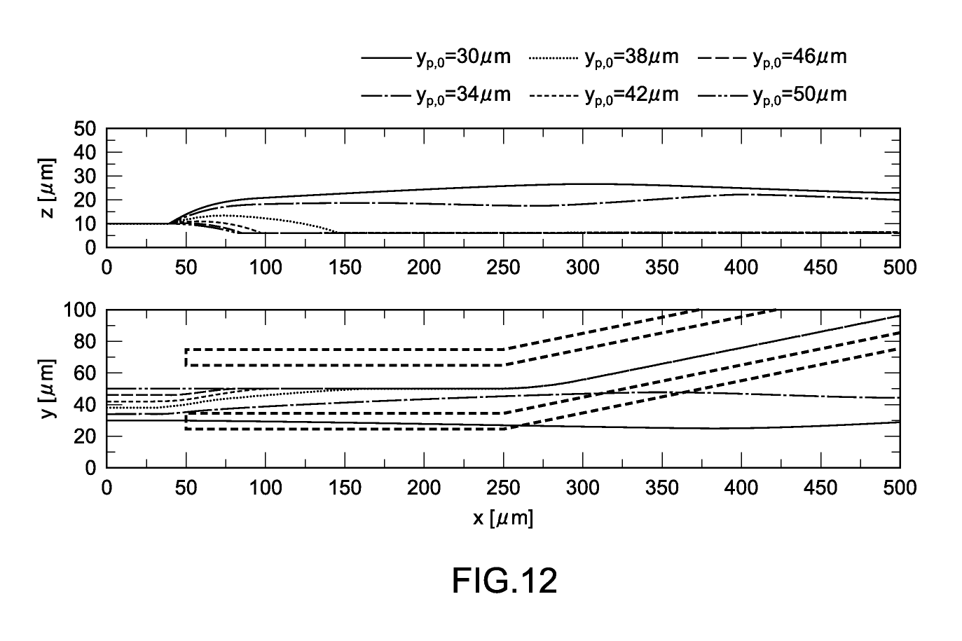

FIG. 12 is a diagram showing a simulation result of tracks of particles in the case where the particles flow into an area where the guide electrode structure 82 is disposed from different positions in the y direction. The upper diagram of FIG. 12 is viewed in the y direction, and the lower diagram thereof is viewed in the z direction.

As shown in the lower graph of FIG. 12, out of the particles that flow into the area in the guide electrode 83, particles other than particles (y_{p,0}=34 μm) having a track indicated by a dotted and dashed line move through a path along the guide electrodes 83 and 84. Particles that pass through an area closer to the center between the guide electrodes 83 and 84 in the y direction are less likely to be affected by the dielectrophoretic force in the upward z direction, and stably move through a path along the guide electrode structure 82 by F_{DEPy} toward inside and the dielectrophoretic force in the downward z direction. Particles that pass through an area which is more distant from the center between the guide electrodes 83 and 84 in the y direction are more likely to be affected by the dielectrophoretic force in the upward z direction, but moves through the path along the guide electrode structure 82 by a force attracted to the center by F_{DEPy} toward inside.

The particles having the track indicated by the dotted and dashed line are brought into a state where the height in the z direction is relatively high in the vicinity of x=50 μm, and F_{DEPy} becomes small (see, FIG. 11), and therefore the particles go straight in the x direction as they are. Further, the particles that flow into the area above the guide electrode 84 (particles having a track indicated by the solid line (y_{p,0}=30 μm)) also show the same result.

As described above, by the flow channel device 50 according to this embodiment, because the area of the common electrode 81 and the area of the guide electrode 83 (and 84) are different from each other, the sorting electrode unit 8 is capable of forming the guide electrical field having the non-uniform electric flux density in the flow channel 2. In addition, because the guide electrical field is formed so that the target particle C1 is guided to the branch channel 2a predetermined, the flow channel device 50 is capable of sorting the particles appropriately.

Further, the shapes of the guide electrodes 83 and 84 are elongated shapes. Therefore, as the width of the common electrode 81 is longer than those of the guide electrodes 83 and 84, the degree of freedom of positioning of the guide electrodes 83 and 84 with respect to positioning of the common electrode 81 is increased in the manufacture of the flow channel device 50. In other words, a precise alignment of the guide electrodes 83 and 84 with respect to the common electrode 81 is unnecessary. Furthermore, as a result, the productivity of the flow channel device 50 is improved, and thus it is possible to save the cost.

In this embodiment, the two elongated guide electrodes 83 and 84 are provided, with the result that the guide electrical field is easily formed, and the particles are easily guided to the branch channel 2a. Thus, it is possible to increase the sorting accuracy.

### Second Embodiment

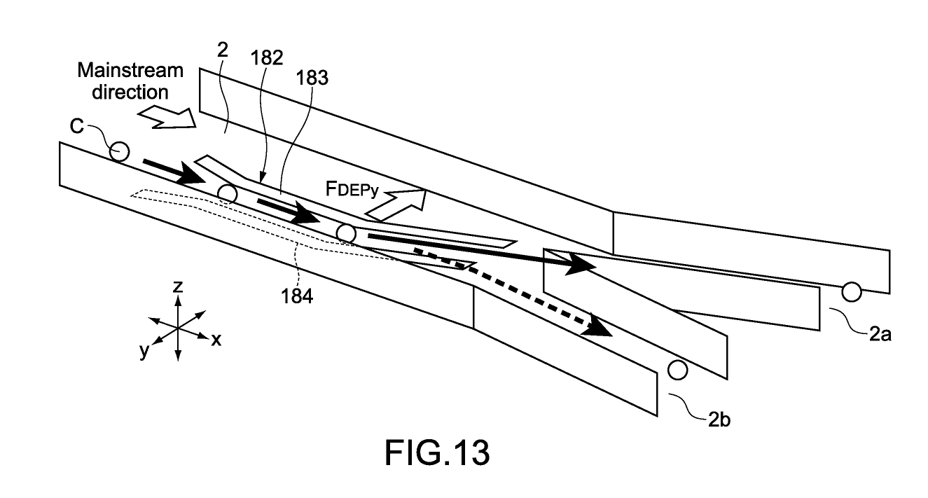

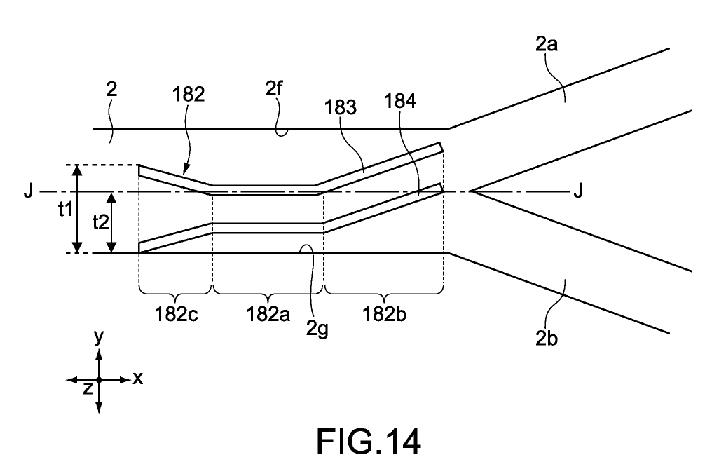

FIG. 13 is a schematic perspective view showing a sorting unit of a flow channel device according to a second embodiment of the present disclosure, and FIG. 14 is a schematic plan view thereof. In the following description, the description of the same parts, functions, and the like as those of the particle sorting apparatus 100 and the flow channel device 50 according to the embodiment described with reference to FIGS. 1 to 3 and the like will be simplified or omitted, and different points will be mainly described.

A guide electrode structure 182 according to this embodiment has an entrance portion 182c provided at an end portion on the upstream side thereof. Here, a linear portion 182a and a direction change portion 182b are set as a main portion. In the entrance portion 182c, a distance between the guide electrodes 183 and 184 (second distance) is formed to be longer than a distance therebetween in the main portion (first distance). In this embodiment, the distance between the guide electrodes 183 and 184 in the entrance portion 182c is formed so as to be increased toward the upstream side. More specifically, both of the two guide electrodes 183 and 184 are bent so that directions thereof are changed from the mainstream direction toward the upstream side.

A common electrode (not shown) has the same shape and the like as the common electrode 81 according to the first embodiment.

Because of the shape of the entrance portion 182c of the guide electrode structure 182 as described above, even if positions in the y direction vary depending on the particles C, the particles C are likely to be attracted into an area between the guide electrodes 183 and 184 in the main portion of the guide electrode structure 182. That is, in an area up to a sorting electrode unit in the flow channel 2, it is possible to set an allowable range of the positions of the particles in the y direction to be larger. Further, the degree of freedom of positioning of the input hole 3c (see, FIG. 2) is increased.

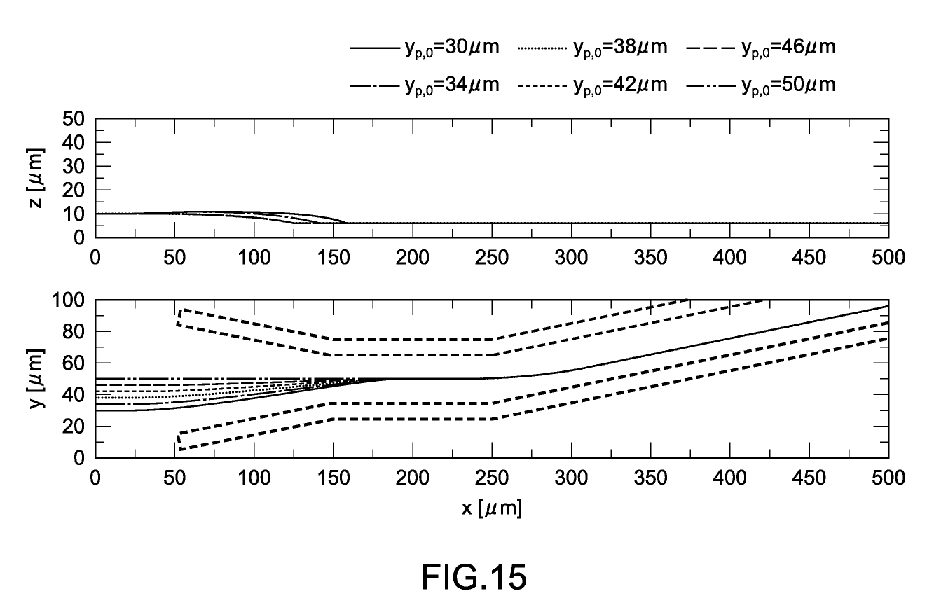

FIG. 15 is a diagram showing a simulation result of tracks of the particles with the flow channel device shown in FIGS. 13 and 14. The intent of this simulation is the same as that described with reference to FIG. 12. In the simulation shown in FIG. 15, the particles having the same variations similar to the case of FIG. 12 in the y direction are entirely attracted to the area between the guide electrodes 183 and 184.

It should be noted that FIGS. 16A and 16B are diagrams showing design examples of approach sections of the guide electrode structures 82 and 182 according to the first and second embodiments, respectively. The values of those figures may be values shown in the table on the lower part of FIG. 7.

To efficiently guide the particles by the guide electrical field, the bend angle, the size, the shape of the entrance portion, and the like can be designed in consideration of a particle size, a height, a width of the flow channel in accordance with a liquid material, or the speed of the particle, for example.

As an example, as shown in FIG. 14, a width t1 of the end portion of the entrance portion 182c on the upstream side is designed as follows. The width t1 is set to be larger than a distance from an inner side surface 2g provided on the branch channel 2b (second branch channel) side in the y direction, out of an inner side surface 2f and the inner side surface 2g of the flow channel 2, which are opposed to each other, to the branch position of the branch channel 2a (first branch channel) and the branch channel 2b in the y direction (i.e., distance to the branch reference line J).

Alternatively, as shown in FIG. 14, the guide electrode structure 182 is designed so that at least a part of the entrance portion (182c) of the guide electrode 183 on the branch channel 2a side in the y direction, of the pair of the guide electrodes 183 and 184, is disposed on the branch channel 2a side in the y direction from the branch position of the branch channels 2a and 2b.

Alternatively, in consideration of the variation of positions where the particles exist in the y direction, the distance between the guide electrodes 183 and 184 of the entrance portion 182c may be designed. For example, when the variation in the y direction is represented in a normal distribution, in the case of a standard deviation σ, the width t1 of the end portion of the entrance portion 182c on the upstream side may set to have a width (that exceeds 1(3) larger than a width of σ.

### Third Embodiment

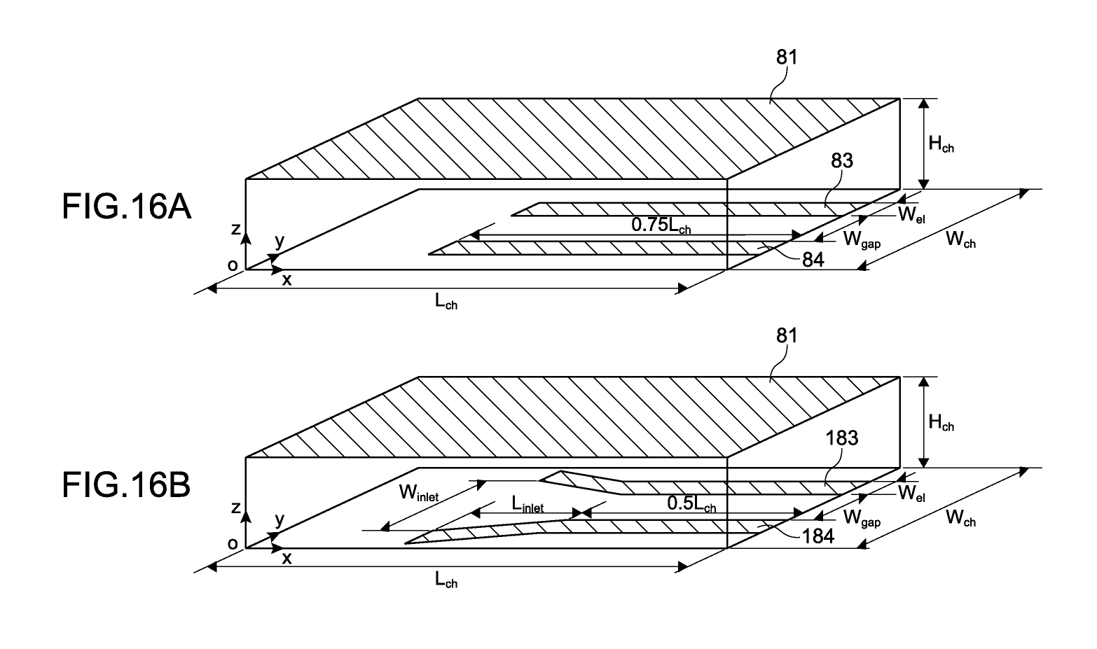

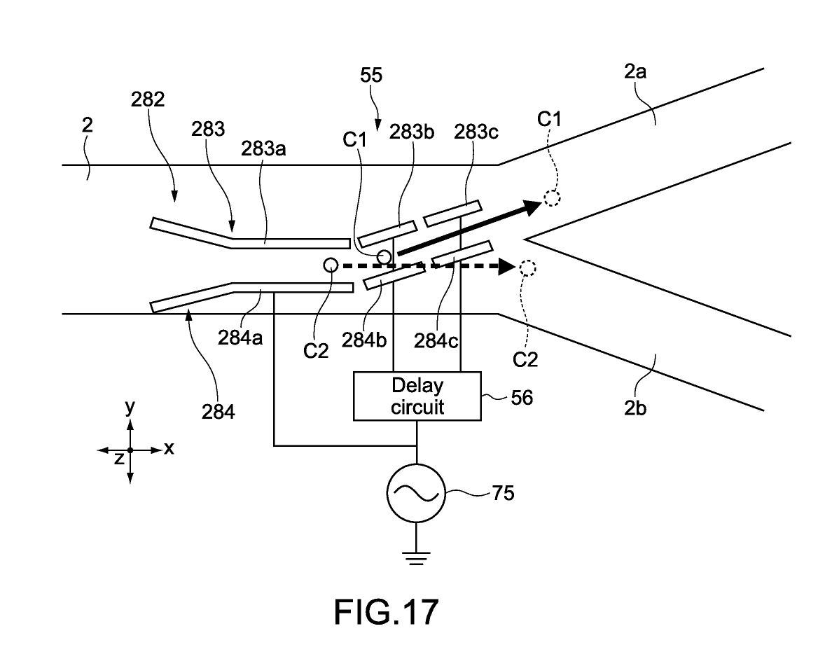

FIG. 17 is a schematic plan view showing a sorting unit of a flow channel device according to a third embodiment of the present disclosure.

A sorting unit 55 includes a guide electrode structure 282 which is sectioned into a plurality of sectioned electrodes along the x direction. For example, guide electrodes 283 and 284 are each sectioned into three parts (283a to 283c and 284a to 284c) in a length direction. The sectioned electrodes 283b, 283c, 284b, and 284c of the direction change portion are connected to a delay circuit 56. The sectioned electrodes 284a and 284b in an approach section are not connected to the delay circuit 56.

For example, during an operation of the flow channel device, a drive voltage is applied to the sectioned electrodes 283a and 284a in the approach section so that those electrodes are on all the time, or the drive voltage may be applied thereto in a cycle in which those electrodes are regarded as being on all the time. Further, behind timing at which a drive voltage synchronized is applied to the sectioned electrodes 283b and 284b, a drive voltage synchronized is applied to the sectioned electrodes 283c and 284c. The delay time is set as appropriate in accordance with the flow speed of the liquid and an input cycle of particles to be described below.

Before a sorting process, in an area where the sorting electrode unit is disposed, the input cycle of particles is preset so as to cause a plurality of particles to exist in the mainstream direction. For example, in a predetermined flow speed of the liquid, the input cycle corresponds to a pitch between the sectioned electrodes 283b (283c) and 284b (284c). The input cycle may of course be longer than the cycle.

For example, the particle sorting apparatus switches application of the drive voltage from the division electrode 283b (284b) to the division voltage 283c (284c) in accordance with the flowage of the target particle C1 that is previously input and is on the downstream side. As a result, the target particle C1 is guided to the branch channel 2a. Thus, at a timing when a non-target particle C2 that is input thereafter and is on the upstream side flows into an area between the sectioned electrodes 283b and 284b, the drive voltage applied to the sectioned electrodes 283b and 284b is off as described above. Thus, the non-target particle C2 is caused to flow into the branch channel 2b.

According to this embodiment, it is possible to cause the plurality of particles to flow along the mainstream direction into the area where the sorting electrode unit is disposed, so the throughput of the sorting process is improved.

It should be noted that in this embodiment, the sectioned electrodes 283a and 284a of the entrance portion of the guide electrode structure 282 have the shape that is expanded toward the upstream side, but may have a linear shape in the mainstream direction as in the first embodiment.

### Another Embodiment

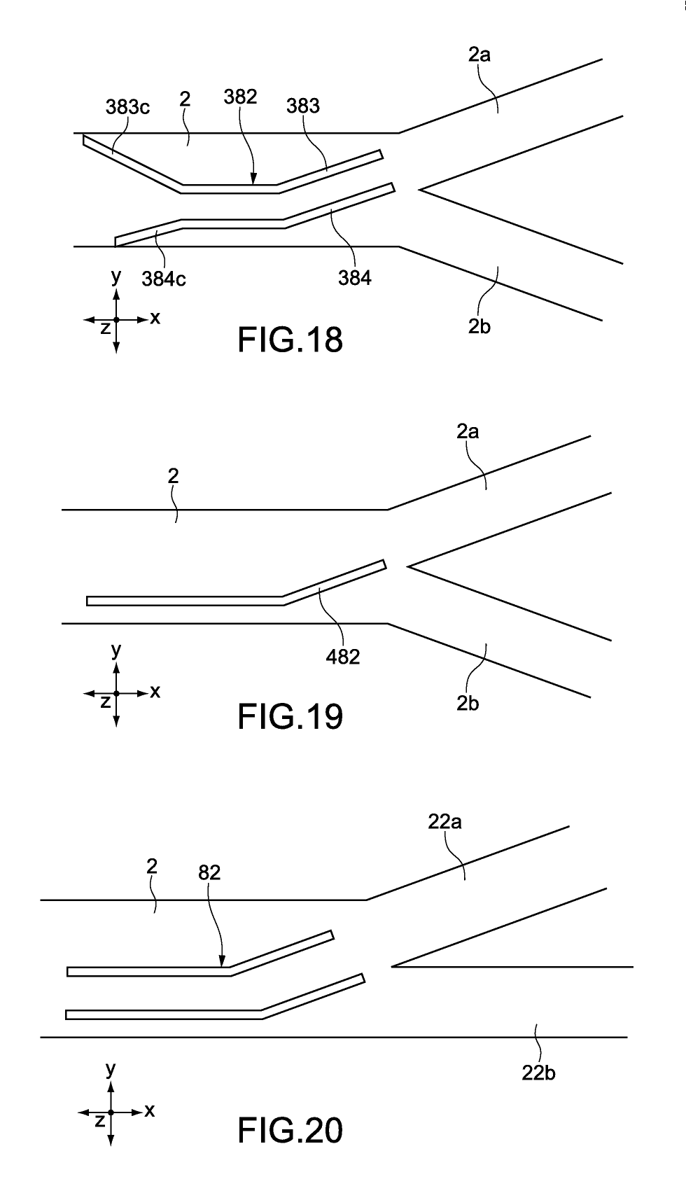

FIGS. 18 to 21 are plan views each schematically showing a guide electrode structure according to another embodiment.

In a guide electrode structure 382 shown in FIG. 18, an entrance portion 383c of a guide electrode 383 on the inner side is formed to be longer than an entrance portion 384c and approaches a side wall of the flow channel 2.

In an example shown in FIG. 19, only one guide electrode 482 is provided. Depending on the size of a particle, the size of the flow channel 2, or the like, there is a case where only one guide electrode 482 is sufficient.

In an example shown in FIG. 20, the mainstream direction of the flow channel 2 and a flow direction of a branch channel 22b are substantially the same direction (x direction). An angle of a branch channel 22a with respect to the branch channel 22b is set as appropriate.

The present disclosure is not limited to the embodiments described above and can implement various other embodiments as follows.

As the guide electrode structure according to the above embodiments, the two guide electrodes are used as an example. However, three or more guide electrodes may be provided.

The drive voltage applied to the sorting electrode unit according to the above embodiments is set as the alternate current but may be direct current.

Instead of the entrance portion 182c of the guide electrode structure 182 according to the embodiment described with reference to FIGS. 13 and 14, the following structure of an entrance portion may be used. That is, for example, the guide electrode 83 may be formed so that the distance between the guide electrodes of the entrance portion is increased stepwise toward the upstream side. Alternatively, as an entrance portion of another example, one of the guide electrodes may be linearly formed toward the upstream side, and the other may be formed so as to be distanced relative to the linearly formed entrance portion.

In the flow channel device shown in FIG. 17, the electrode of the direction change portion is the sectioned electrodes (283b, 283c, 284b, and 284c) in the x direction. However, the electrodes of the direction change portion may not be the sectioned electrodes but may be one electrode in the x direction. That is, in this case, the guide electrode structure has sectioned electrodes (an electrode in the approach section and an electrode in the direction change portion) which are sectioned into two in the x direction.

The bend angles α of the direction change portion 82b of the two guide electrodes 82 and 83 shown in FIG. 4 and the like are set to be equal but may be different angles.

The flow channel, the branch channels, and the like according to the above embodiments are linear shapes but may be curved shapes. The cross-sectional shape of the flow channel is a rectangle but may be a circle, an oval, a polygon other than a quadrangle, or a shape obtained by combining those shapes.

The shape of the common electrode is a rectangle but may be a circle, an ellipse, an oval, a polygon, or any other shapes. Further, the shape of the common electrode can be a different shape depending on the shape of the flow channel 2.

The measurement unit measures the impedance depending on the particles but may measure a fluorescent intensity or a scattered light intensity depending on the particles. The analysis unit generates a sorting signal on the basis of the values obtained by the measurement.

### Fourth Embodiment

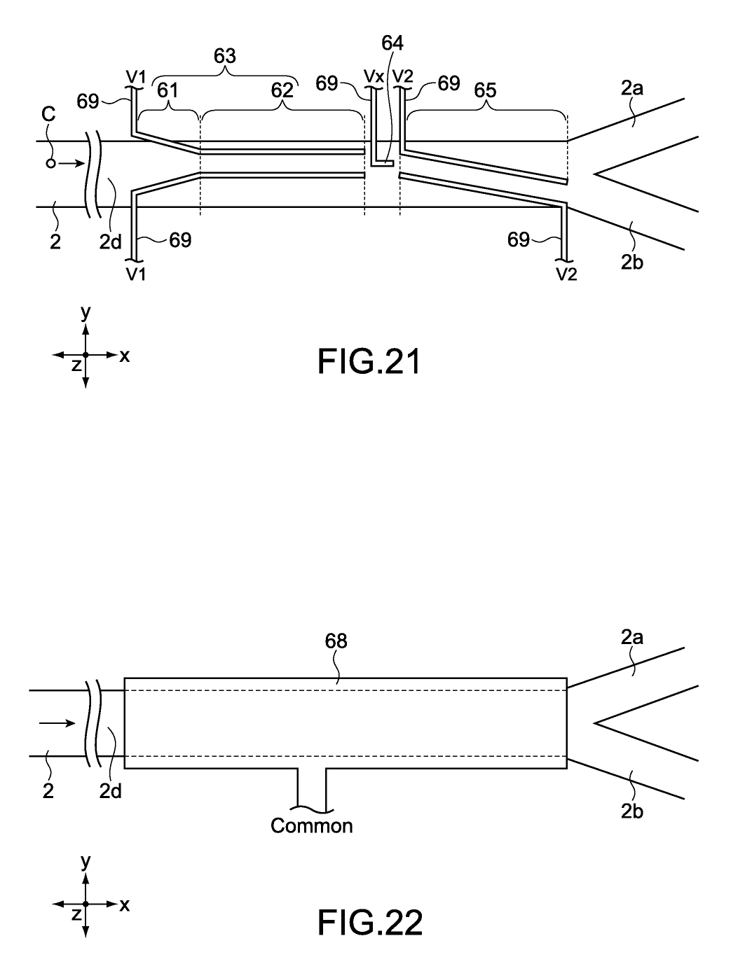

FIG. 21 is a plan view showing a sorting electrode unit of a flow channel device according to a fourth embodiment of the present disclosure. FIG. 22 is a plan view mainly showing a common electrode of the sorting electrode unit shown in FIG. 21.

As shown in FIG. 21, the sorting electrode unit according to this embodiment has an upstream portion 63 (including an entrance portion 61 and a linear portion 62), a switching portion 64, and a direction change portion 65, which are arranged in order from the upstream side. That is, the switching portion 64 is provided between the upstream portion 63 and the direction change portion 65 in the x direction as the mainstream direction. The upstream portion 63, the switching portion 64, and the direction change portion 65 are arranged at predetermined intervals in the x direction as the mainstream direction. The direction change portion 65 is formed in a slanting direction so as to be deviated from the mainstream direction toward the branch channel 2b of the two branch channels 2a and 2b.

The upstream portion 63 and the direction change portion 65 are each constituted of a pair of parallel electrodes formed to be elongated (a pair of guide electrodes). On the other hand, the switching portion 64 is formed of a single electrode formed to be elongated. As shown in FIG. 22, a common electrode 68 is provided above the flow channel 2 so as to be opposed to the electrodes provided on a bottom surface 2d of the flow channel 2, that is, so as to cover the upstream portion 63, the switching portion 64, and the direction change portion 65 in a plan view. As in the above embodiments, those electrodes are electrically connected to the analysis unit 70 and the AC power source 75 which function as a signal generation unit.

It should be noted that, in FIGS. 21 and 22, leads 69 are connected to the electrodes as an example, but the leads 69 are not shown in the first to third embodiments. In addition, in this embodiment, a part of the entrance portion 61 and the both sides of the common electrodes 68 in the y direction are extended off the side walls of the flow channel 2. Such an electrode arrangement can be designed.

The signal generation unit applies voltages V1 and V2 to the upstream portion 63 and the direction change portion 65, respectively and applies a voltage Vx to the switching portion 64 at a predetermined timing. To the upstream portion 63 and the direction change portion 65, an AC voltage having a predetermined relatively high frequency, e.g., 100 kHz to 100 MHz, is applied. On the other hand, to the switching portion 64, a voltage is applied at a timing voltage in accordance with a sorting process of particles based on complex impedance measured by the measurement unit 60. That is, the signal generation unit applies the voltage to the switching portion 64 at a timing to be switched in order to switch a direction of the flow of the particles, as will be described later.

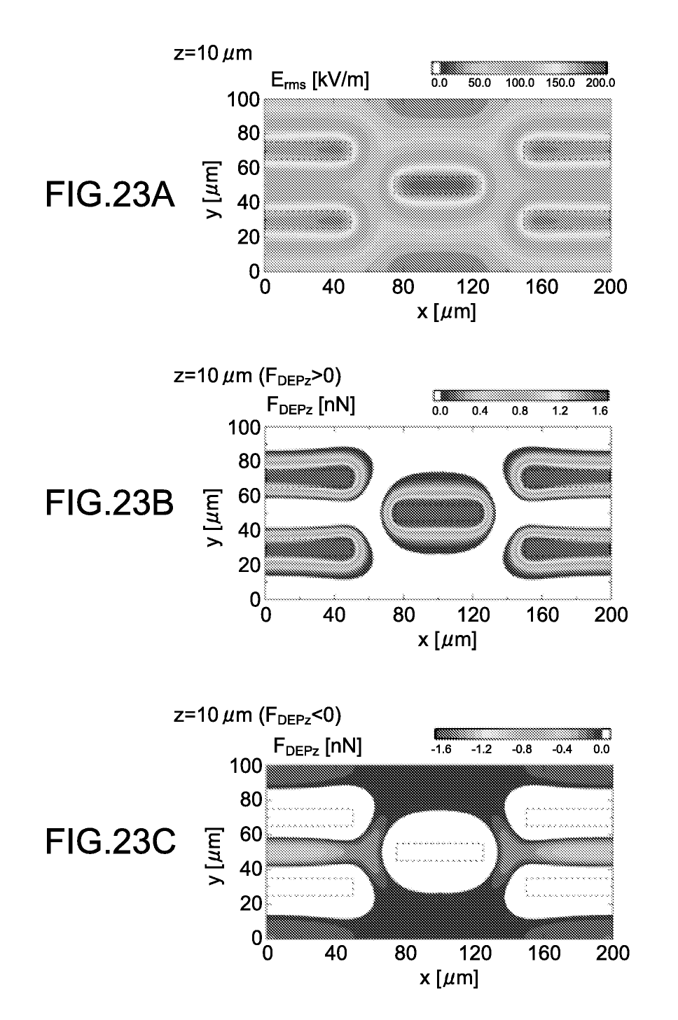

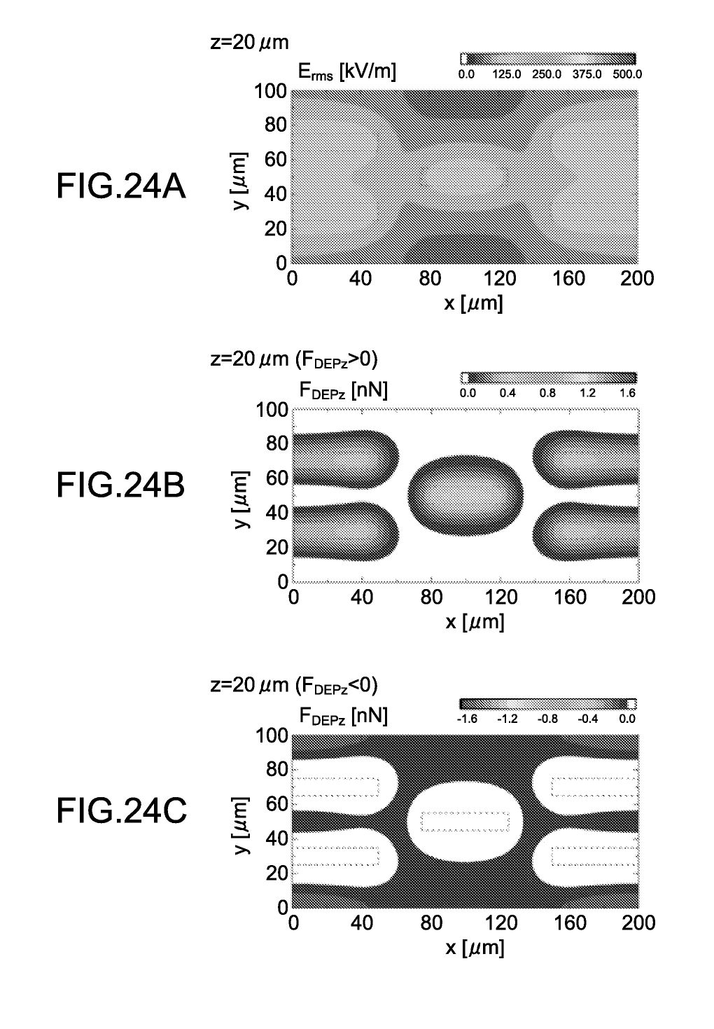

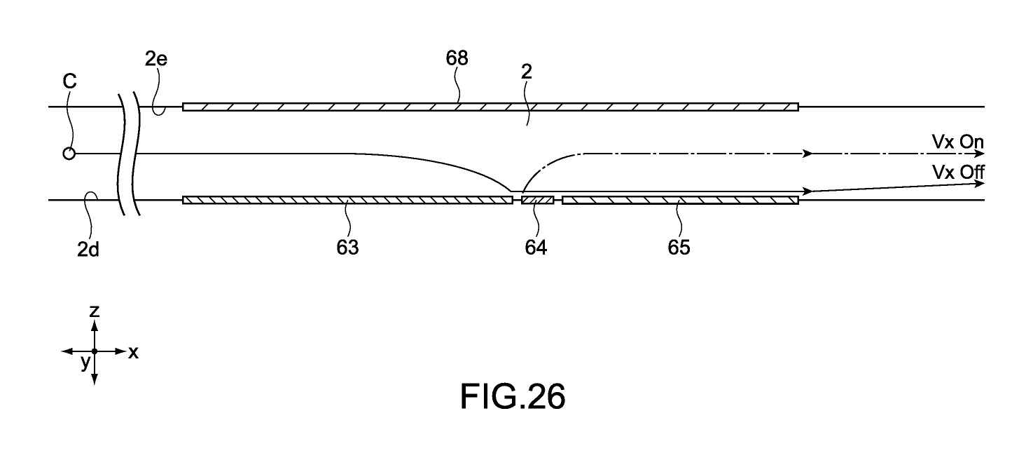

FIG. 23A is a diagram showing an intensity distribution of an electrical field at the flow channel depth z=10 μm on the x-y plane. FIG. 23B is a diagram showing an intensity distribution of a dielectrophoretic force generated only in a direction (conveniently upward direction) from the bottom surface 2d to a ceiling surface 2e (see, FIG. 26) on the x-y plane, out of the dielectrophoretic force F_{DEPz} generated in the z direction at the depth z=10 μm by the electrical field shown in FIG. 23A. FIG. 23C is a diagram showing an intensity distribution of a dielectrophoretic force generated only in a direction (conveniently downward direction) from the ceiling surface 2e to the bottom surface 2d on the x-y plane, out of the dielectrophoretic force F_{DEPz} generated in the z direction at the depth z=10 μm by the electrical field shown in FIG. 23A. FIG. 24A is a diagram corresponding to FIG. 23A and showing the intensity distribution of an electrical field at a flow channel depth z=20 μm on the x-y plane, and FIGS. 24B and 24C are diagrams corresponding to FIGS. 23B and 23C, respectively, and showing the intensity distribution of dielectrophoretic forces generated in the z direction (upward and downward directions) at the flow channel depth z=20 μm on the x-y plane. The width of the flow channel and the height of the flow channel in the y direction are the same as those shown in FIG. 7.

In addition, FIGS. 23 and 24 show the electrical fields and the dielectrophoretic forces on the entire portion of the switching portion 64, the end portion of the upstream portion 63 on the downstream side, and the end portion of the direction change portion 65 on the upstream side. A basic way of viewing the diagrams is the same as that for FIGS. 8 to 10. Here, the height position of the bottom surface 2d of the flow channel 2 is set to z=0. Further, in those figures, as described above, the electrical field and the dielectrophoretic force when the voltages V1 and V2 are applied to the upstream portion 63 and the direction change portion 65, respectively, and the voltage Vx is applied to the switching portion 64. In actuality, the applicant of the present disclosure can disclose FIGS. 23 and 24 as color figures.

As described in the above embodiments, in the upstream portion 63 and the direction change portion 65, by forming the electrical field which is gradually weakened from the center portion in the height of the flow channel 2 toward the bottom surface 2d, the guide electrical field is formed so that the particle C is attracted to the bottom surface 2d. On the other hand, in the vicinity of the switching portion 64, when the voltage Vx is applied to the switching portion 64, the non-uniform electrical field which is weakened from the bottom surface 2d toward the ceiling surface so that the dielectrophoresis is developed between the switching portion and the common electrode 68 provided thereabove. Therefore, when the voltage Vx is applied, the particle C is attracted to the upper portion.

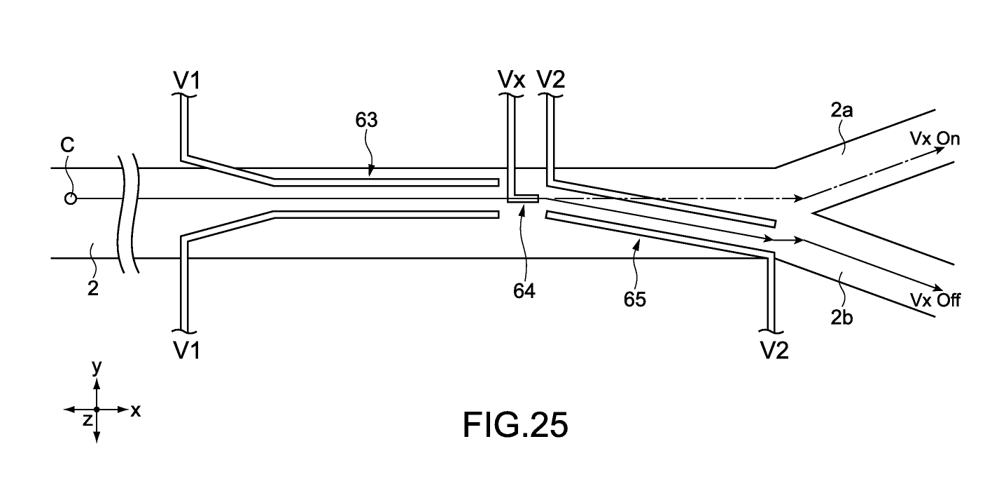

FIG. 25 is a diagram for explaining a behavior of a particle in the case where the voltages V1 and V2 are applied to the electrodes. FIG. 26 is a diagram when FIG. 25 is viewed in the y direction.

In the case where the flow channel height is equal to or smaller than the flow channel width, under a condition of a laminar flow, a parabolic flow rate distribution is generated in a height direction on the center portion of the flow channel width direction (y direction). With this distribution, the particle C flowing in the vicinity of the center of the flow channel height is attracted to a lower wall in the upstream portion 63 to which the voltage V1 is applied, and the speed thereof is lowered. Further, such a state is caused in the same way in the direction change portion 65 to which the voltage V2 is applied.

As shown in FIGS. 25 and 26, in the state in which the voltages V1 and V2 are applied to the upstream portion 63 and the direction change portion 65, in the case where the voltage Vx is not applied to the switching portion 64, the particle C passes through the switching portion 64 while maintaining the height at the time of being attracted downward in the upstream portion 63 and moves to the direction change portion 65. As a result, the particle C is subjected to the dielectrophoretic force of a component in the downward direction and in the flow channel width direction, and thus can change the position thereof in the width direction in the flow channel 2, that is, change the direction in the direction change portion 65, thereby being guided to the branch channel 2b.

On the other hand, in the case where the voltage Vx is applied to the switching portion 64 in the state in which the voltages V1 and V2 are applied to the upstream portion 63 and the direction change portion 65, the particle C that flows on the bottom surface 2d side in the upstream portion 63 is subjected to a strong dielectrophoretic force in the upward direction in the switching portion 64 and thus moves to the vicinity of the center portion in the flow channel height and accelerates in the flow direction. Thus, the particle C moves to the direction change portion 65, but it may be impossible to sufficiently obtain the dielectrophoretic force in the downward direction and in the flow channel width direction, so the particle C hardly change its position from the flowing position in the upstream portion 63 in the flow channel width direction. As a result, the particle C is guided to the branch channel 2a as it is.

As described above, by the flow channel device provided with the sorting electrode unit according to this embodiment, by switching on and off of the voltage Vx in time with the passing through the switching portion 64, it is possible to reliably switch the direction of the flow of the particle C. In particular, the sorting operation is performed in response to the switching timing of the voltage of the switching portion 64, so a high-speed sorting process is achieved as compared to the flow channel device according to the above embodiments.

It should be noted that in the above embodiments, the upward direction and the downward direction are unrelated to a direction of gravitational force and are defined for convenience of explanation.

At least two characteristic parts out of the characteristic parts of the above embodiments can be combined.

It should be noted that the present disclosure can take the following configurations.

(1) A flow channel device, including:

a flow channel in which a fluid containing a particle flows;

a plurality of branch channels branched from the flow channel; and

an electrode unit including a first electrode having a first area and a second electrode having a second area different from the first area, and configured to form a guide electrical field in the flow channel, which guides the particle to a predetermined branch channel out of the plurality of branch channels, the second electrode being opposed to the first electrode so that the flow channel is sandwiched between the first electrode and the second electrode.

(2) The flow channel device according to Item (1), in which

the first electrode is an electrode having a first width in a width direction of the flow channel, and

the second electrode is an elongated electrode having a second width smaller than the first width in the width direction of the flow channel.

(3) The flow channel device according to Item (2), in which

the second electrode includes
a linear portion provided along a mainstream direction of the fluid in the flow channel, and
a direction change portion provided to change a direction from the linear portion toward the predetermined branch channel.

(4) The flow channel device according to any one of Items (1) to (3), in which

the electrode unit includes a plurality of second electrodes.

(5) The flow channel device according to Item (4), in which

at least two electrodes out of the plurality of second electrodes are a pair of guide electrodes elongated along a mainstream direction of the fluid.

(6) The flow channel device according to Item (5), in which

the pair of guide electrodes includes
a main portion in which a distance between the pair of guide electrodes is a first distance, and
an entrance portion which is provided on an end portion of the pair of guide electrodes on an upstream side and in which a distance between the pair of guide electrodes is a second distance longer than the first distance.

(7) The flow channel device according to Item (6), in which

the distance between the pair of guide electrodes in the entrance portion is gradually increased toward the upstream side.

(8) The flow channel device according to Item (6) or (7), in which

the plurality of branch channels include a first branch channel, which is the predetermined branch channel, and a second branch channel adjacent to the first branch channel, and

the second distance is longer than a distance from an inner side surface of the flow channel which is provided on the second branch channel side in a width direction of the flow channel to a branch position of the first branch channel and the second branch channel in the width direction of the flow channel.

(9) The flow channel device according to Item (6) or (7), in which

the plurality of branch channels include a first branch channel, which is the predetermined branch channel, and a second branch channel adjacent to the first branch channel, and

at least a part of the entrance portion of the guide electrode of the pair of guide electrodes, which is provided on the first branch channel side in a width direction of the flow channel, is disposed on the first branch channel side in the width direction of the flow channel in relation to a branch position of the first branch channel and the second branch channel.

(10) The flow channel device according to any one of Items (4) to (9), in which

the electrode unit is configured to form the guide electrical field by voltages having the same potential which are applied to the plurality of second electrodes.

(11) The flow channel device according to any one of Items (1) to (10), in which

the first electrode is a common electrode, and

the second electrode is an electrode to which a voltage is actively applied.

(12) The flow channel device according to Item (1), in which

the electrode unit includes a switching portion that switches a direction of a flow of the particle.

(13) The flow channel device according to Item (1), in which

the electrode unit includes
a pair of guide electrodes elongated along a mainstream direction of the fluid and serving as the second electrodes, and
a switching portion configured to switch a direction of a flow of the particle.

(14) The flow channel device according to Item (13), in which

the pair of guide electrodes includes
a linear portion provided along the mainstream direction of the fluid in the flow channel, and
a direction change portion provided to change a direction from the linear portion toward the predetermined branch channel, and

the switching portion is disposed between the linear portion and the direction change portion.

(15) A particle sorting apparatus, including:

a flow channel device including
a flow channel in which a fluid containing a particle flows,
a plurality of branch channels branched from the flow channel,
a measurement electrode unit provided on a first position of the flow channel, and
a sorting electrode unit that includes a first electrode having a first area and a second electrode having a second area different from the first area, is provided on a second position on a downstream side from the first position of the flow channel, and is configured to form a guide electrical field in the flow channel, which guides the particle to a predetermined branch channel out of the plurality of branch channels, the second electrode being opposed to the first electrode so that the flow channel is sandwiched between the first electrode and the second electrode;

a measurement unit configured to measure an impedance that depends on the particle by applying an AC voltage to the measurement electrode unit; and

a signal generation unit configured to generate a sorting signal that gives an instruction to sort the particle by the guide electrical field on the basis of the impedance measured and apply the sorting signal to the sorting electrode unit.

(16) The particle sorting apparatus according to Item (15), in which

the sorting electrode unit includes a switching portion that switch a direction of a flow of the particle.

(17) The particle sorting apparatus according to Item (16), in which

the signal generation unit is configured to control a voltage signal applied to the switching portion in accordance with a sorting process of the particle based on the impedance measured.

(18) A particle sorting method, including:

flowing a fluid containing a particle in a flow channel;

measuring an impedance that depends on the particle by applying an AC voltage to a measurement electrode unit provided on a first position of the flow channel;

generating a sorting signal that gives an instruction to sort the particle on the basis of the impedance measured; and

forming, in the flow channel, a guide electrical field that guides the particle to a predetermined branch channel out of a plurality of branch channels branched from the flow channel by applying the sorting signal generated to a sorting electrode unit including a first electrode having a first area and a second electrode having a second area different from the first area and provided on a second position on a downstream side from the first position of the flow channel, the second electrode being opposed to the first electrode so that the flow channel is sandwiched between the first electrode and the second electrode.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A flow channel device, comprising:
a flow channel in which a fluid containing a particle flows;
a plurality of branch channels branched from the flow channel; and
an electrode unit including a first electrode having a first area and a second electrode having a second area different from the first area, and configured to form a guide electrical field in the flow channel, which guides the particle to a predetermined branch channel out of the plurality of branch channels, the second electrode being opposed to the first electrode so that the flow channel is sandwiched between the first electrode and the second electrode.

2. The flow channel device according to claim 1, wherein
the first electrode is an electrode having a first width in a width direction of the flow channel, and
the second electrode is an elongated electrode having a second width smaller than the first width in the width direction of the flow channel.

3. The flow channel device according to claim 2, wherein
the second electrode includes
a linear portion provided along a mainstream direction of the fluid in the flow channel, and
a direction change portion provided to change a direction from the linear portion toward the predetermined branch channel.

4. The flow channel device according to claim 1, wherein
the electrode unit includes a plurality of second electrodes.

5. The flow channel device according to claim 4, wherein
at least two electrodes out of the plurality of second electrodes are a pair of guide electrodes elongated along a mainstream direction of the fluid.

6. The flow channel device according to claim 5, wherein
the pair of guide electrodes includes
a main portion in which a distance between the pair of guide electrodes is a first distance, and
an entrance portion which is provided on an end portion of the pair of guide electrodes on an upstream side and in which a distance between the pair of guide electrodes is a second distance longer than the first distance.

7. The flow channel device according to claim 6, wherein
the distance between the pair of guide electrodes in the entrance portion is gradually increased toward the upstream side.

8. The flow channel device according to claim 6, wherein
the plurality of branch channels include a first branch channel, which is the predetermined branch channel, and a second branch channel adjacent to the first branch channel, and
the second distance is longer than a distance from an inner side surface of the flow channel which is provided on the second branch channel side in a width direction of the flow channel to a branch position of the first branch channel and the second branch channel in the width direction of the flow channel.

9. The flow channel device according to claim 6, wherein
the plurality of branch channels include a first branch channel, which is the predetermined branch channel, and a second branch channel adjacent to the first branch channel, and
at least a part of the entrance portion of the guide electrode of the pair of guide electrodes, which is provided on the first branch channel side in a width direction of the flow channel, is disposed on the first branch channel side in the width direction of the flow channel in relation to a branch position of the first branch channel and the second branch channel.

10. The flow channel device according to claim 4, wherein
the electrode unit is configured to form the guide electrical field by voltages having the same potential which are applied to the plurality of second electrodes.

11. The flow channel device according to claim 1, wherein
the first electrode is a common electrode, and
the second electrode is an electrode to which a voltage is actively applied.

12. The flow channel device according to claim 1, wherein
the electrode unit includes a switching portion that switches a direction of a flow of the particle.

13. The flow channel device according to claim 1, wherein
the electrode unit includes
a pair of guide electrodes elongated along a mainstream direction of the fluid and serving as the second electrodes, and
a switching portion configured to switch a direction of a flow of the particle.

14. The flow channel device according to claim 13, wherein
the pair of guide electrodes includes
a linear portion provided along the mainstream direction of the fluid in the flow channel, and
a direction change portion provided to change a direction from the linear portion toward the predetermined branch channel, and
the switching portion is disposed between the linear portion and the direction change portion.

15. A particle sorting apparatus, comprising:
a flow channel device including
a flow channel in which a fluid containing a particle flows,
a plurality of branch channels branched from the flow channel,
a measurement electrode unit provided on a first position of the flow channel, and
a sorting electrode unit that includes a first electrode having a first area and a second electrode having a second area different from the first area, is provided on a second position on a downstream side from the first position of the flow channel, and is configured to form a guide electrical field in the flow channel, which guides the particle to a predetermined branch channel out of the plurality of branch channels, the second electrode being opposed to the first electrode so that the flow channel is sandwiched between the first electrode and the second electrode;
a measurement unit configured to measure an impedance that depends on the particle by applying an AC voltage to the measurement electrode unit; and
a signal generation unit configured to generate a sorting signal that gives an instruction to sort the particle by the guide electrical field on the basis of the impedance measured and apply the sorting signal to the sorting electrode unit.

16. The particle sorting apparatus according to claim 15, wherein
the sorting electrode unit includes a switching portion that switch a direction of a flow of the particle.

17. The particle sorting apparatus according to claim 16, wherein
the signal generation unit is configured to control a voltage signal applied to the switching portion in accordance with a sorting process of the particle based on the impedance measured.

18. A particle sorting method, comprising:
flowing a fluid containing a particle in a flow channel;
measuring an impedance that depends on the particle by applying an AC voltage to a measurement electrode unit provided on a first position of the flow channel;
generating a sorting signal that gives an instruction to sort the particle on the basis of the impedance measured; and
forming, in the flow channel, a guide electrical field that guides the particle to a predetermined branch channel out of a plurality of branch channels branched from the flow channel by applying the sorting signal generated to a sorting electrode unit including a first electrode having a first area and a second electrode having a second area different from the first area and provided on a second position on a downstream side from the first position of the flow channel, the second electrode being opposed to the first electrode so that the flow channel is sandwiched between the first electrode and the second electrode.
